(19) United States
(12) Patent Application Publication
(10) Pub. No.: US 2010/0323111 A1
(43) Pub. Date: Dec. 23, 2010

(54) Colloidal Palladium Activators and Methods Thereof

(75) Inventors: Qing Gong, Shenzhen (CN); Jialiang Wei, Shenzhen (CN); Junlan Lian, Shenzhen (CN)

Correspondence Address: GREENBERG TRAURIG (HOU);INTELLECTUAL PROPERTY DEPARTMENT, 1000 Louisiana Street, Suite 1700, Houston, TX, 77002, US

(73) Assignee: BYD Company Limited

(21) Appl. No.: 12/819,864

(22) Filed: Jun. 21, 2010

(30) Foreign Application Priority Data
Jun. 22, 2009 (CN) 200910108122.1

(51) Int. Cl. B05D 3/02; H01B 1/22; B05D 3/10

(52) U.S. Cl. 427/314; 252/514

(57) ABSTRACT

A colloidal palladium activator is provided which includes colloidal palladium particles; sodium chloride; glyoxylic acid; hydrochloride solution; stannous chloride; and a stabilizer.

### CROSS-REFERENCE TO RELATED APPLICATION

This application claims the priority and benefit of Chinese Patent Application No. CN200910108122.1, filed with State Intellectual Property Office, P. R. C., on Jun. 22, 2009.

### FIELD OF THE PRESENT DISCLOSURE

The present disclosure relates generally to colloidal palladium activators and methods thereof. In more particularity, the present disclosure relates to a colloidal palladium activator having colloidal palladium particles; sodium chloride; glyoxylic acid; a hydrochloride solution; stannous chloride; and a stabilizer.

### BACKGROUND OF THE PRESENT DISCLOSURE

Non-metal materials, nonconductive materials, and materials otherwise having low conductivity relative to the conductivity of metals, may be plated by electroless plating techniques. As a non-limiting example, relatively low conductivity materials may include any material having an electrical conductivity less than about 35×10⁶ siemens per meter, alternatively less than about 15×10⁶ siemens per meter. Prior to electroless plating, the material may be subjected to an activation pretreatment, wherein a number of active centers in the surface of the material are absorbed. The activation pretreatment may have a positive effect on the quality and longevity of the plated layers.

### SUMMARY OF THE PRESENT DISCLOSURE

In accordance with various illustrative embodiments hereinafter disclosed are colloidal palladium activators having colloidal palladium particles; sodium chloride; glyoxylic acid; hydrochloride solution; stannous chloride; and a stabilizer.

In accordance with another illustrative embodiment hereinafter disclosed are methods of preparing colloidal palladium activators. The methods may include combining a first hydrochloride solution, a stannous chloride, a glyoxylic acid, and a stabilizer with a sodium chloride solution to form a first solution. The methods may further include combining palladium sodium with a second hydrochloride solution to form a second solution. The methods may additionally include combining stannous chloride to the second solution to form a third solution, and then combining the first and third solution to form the colloidal palladium activator.

While the colloidal palladium activators and methods thereof will be described in connection with various preferred illustrative embodiments, it will be understood that it is not intended to limit the colloidal palladium activators and methods thereof to those embodiments. On the contrary, it is intended to cover all alternatives, modifications, and equivalents as may be included within the spirit and scope of the invention as defined by the appended claims.

### DETAILED DESCRIPTION OF THE EMBODIMENT

### Composition

In an illustrative, non-limiting, embodiment of the present disclosure, a colloidal palladium activator is provided, which may comprise: colloidal palladium particles; sodium chloride; glyoxylic acid; a hydrochloride solution; tin(II) chloride, otherwise referred to herein as stannous chloride; and a stabilizer. In a further illustrative, non-limiting, embodiment, the colloidal palladium particles may have a concentration ranging from about 0.0002 moles per liter (“mol/L”) to about 0.006 mol/L, alternatively from about 0.0004 mol/L to about 0.003 mol/L; the sodium chloride may have a concentration ranging from about 2.567 mol/L to about 3.756 mol/L, alternatively from about 2.75 mol/L to about 3.60 mol/L; the glyoxylic acid may have a concentration ranging from about 0.002 mol/L to about 0.35 mol/L, alternatively from about 0.01 mol/L to about 0.2 mol/L; the hydrochloride solution may have a concentration ranging from about 0.12 mol/L to about 0.96 mol/L, alternatively from about 0.24 mol/L to about 0.72 mol/L; the stannous chloride may have a concentration ranging from about 0.022 mol/L to about 0.088 mol/L, alternatively from about 0.031 mol/L to about 0.066 mol/L; and the stabilizer may have a concentration ranging from about 0.001 mol/L to about 1 mol/L, alternatively from about 0.002 mol/L to about 0.8 mol/L. All concentrations provided herein are based on the total volume of the colloidal palladium activator, unless otherwise indicated. Further, where a range is disclosed all intermediary ranges are all intended to be described and disclosed thereby, unless otherwise indicated. Accordingly, as a non-limiting example, a concentration disclosure of from about 0.0002 to about 0.003 mol/L includes a disclosure of from about 0.0002 mo/L to about 0.029 mol/L, from about 0.0003 mol/L to about 0.003 mol/L, from about 0.0003 to about 0.029 mol/L, and so forth. Notwithstanding, various alternative and preferred ranges may be disclosed herein for clarity of understanding. Moreover, in this disclosure, the terms “mixture” and “solution” are used as reference labels without regard to the homogeneity or non-homogeneity of their components.

Without wishing to be bound by the theory, Applicant believes that the colloidal palladium particles may be absorbed into the surface of the substrate (described in detail below) and may form a plurality of “active centers,” which metallize—or otherwise increase the conductivity of—the surface of the material. Further, without wishing to be bound by the theory, Applicant believes that an even distribution of the colloid palladium particles favors the formation of an even plating layer with a short initiation cycle. In a non-limiting embodiment, the average diameter of colloidal palladium particles in the activator may range from about 80 nanometers to about 300 nanometers, alternatively from about 80 nanometers to about 200 nanometers, and alternatively from about nanometers 100 to about 250 nanometers.

Without wishing to be bound by the theory, Applicant believes that the sodium chloride may function to provide chloride elements, which may form a complex compound with the colloidal palladium particles. The complex compound may disperse the colloidal palladium particles evenly within the activator. Additionally without wishing to be bound by the theory, the sodium chloride may serve to prevent, or otherwise reduce, the occurrence of hydrochloride mist.

Without wishing to be bound by the theory, Applicant believes that the hydrochloride may provide hydrogen and chloride elements to adjust the PH of the activator, as well as stabilize the Sn²⁺ in the activator, making it less susceptible to hydrolysis and/or oxidation. In a non-limiting illustrative embodiment, the colloidal palladium activator may have a PH value ranging from about 0.2 to about 0.9, alternatively from about 0.02 to about 0.7, alternatively from about 0.5 to about 0.7.

Without wishing to be bound by the theory, Applicant believes that the stabilizer may function to prevent the Sn²⁺ from oxidizing, which may enhance, improve, or otherwise increase, the stability of the activator. In this manner, the useful life of the activator may be increased. Suitable stabilizers may include: sodium stannate; urea; ascorbic acid; like compounds; and combinations thereof.

Without wishing to be bound by the theories, Applicant believes that the glyoxylic acid may increase the useful life of the activator because: 1) its reductive ability may protect the Sn²⁺ from oxidation; and/or 2) the glyoxylic acid may prevent coagulation of the colloidal palladium particles by either physically surrounding them, or otherwise electrically charging them, which results in separation of the colloidal palladium particles and a more even distribution of the colloidal palladium particles. Further without wishing to be bound by the theory, Applicant believes that after activation by a colloidal palladium activator having glyoxylic acid, the substrate material may achieve a uniform and flat plating layer having high adhesive strength with the substrate.

The colloidal palladium activator may include a surface wetting agent. Suitable surface wetting agents are generally known to those of ordinary skill in the art, and may include, for example, alcohols such as: isopropanol; methanol; ethanol; and combinations thereof. The wetting agent may have any concentration, and preferable concentrations may range from about 0.003 mol/L to about 0.3 mol/L, alternatively from about 0.01 mol/L to about 0.2 mol/L.

Preparation Methods

In a non-limiting, illustrative, embodiment, a method for preparing a colloidal palladium may include dispersing, mixing, combining, or reacting, a first hydrochloride solution, a stannous chloride, a glyoxylic acid, and a stabilizer into, or with, a sodium chloride solution to prepare a first solution or a first mixture. The method may further include dispersing, mixing, combining, or reacting, a palladium sodium into a second hydrochloride solution to form a second solution or a second mixture. Stannous chloride may be added to the second solution or the second mixture to form a third solution or a third mixture. The first and third mixtures/solutions may be dispersed, mixed, combined, or reacted, to form the colloidal palladium activator. Alternatively, the stannous chloride may be added to the second hydrochloride solution with the palladium sodium and then the resulting mixture/solution may be dispersed, mixed, combined, or reacted with or to the first mixture/solution. Alternatively, a surface wetting agent may dispersed, mixed, combined, or reacted to the sodium chloride solution. During the preparation, the stannous chloride and palladium chloride may undergo the following:

Sn²⁺+Pd²⁺→Sn⁴⁺+Sn⁰,

wherein the molar ratio of palladium chloride to stannous chloride may be less than about 1 and alternatively about 0.5. In an embodiment, the preparation of the second or third mixture/solution may be performed under a reaction temperature ranging from about 20 degrees centigrade (° C.) to about 40° C. for about 10 minutes to 30 minutes.

Substrates

Suitable materials to be plated (“substrates”) may include non-metal materials, non-conductive materials, or materials having a relatively low conductivity including materials having an electrical conductivity less than about 35×10⁶ siemens per meter, alternatively less than about 15×10⁶ siemens per meter. Suitable substrates are generally known to those of ordinary skill in the art, and may include, for example and without limitation, polyimides (“PI”), acrylonitrile butadiene styrene resin (“ABS resin”), polyethylene terephthalate (“PET”), and other materials that are generally hydrophilic after rough treatments.

Substrate Pretreatment

In a non-limiting, illustrative, embodiment, the substrate may be subjected to pretreatment(s) prior to the activation process activation. Pretreatments methods are generally well known to those of ordinary skill in the art, and may include, without limitation, grease removal and rough treatments.

In an embodiment, grease removal may include immersing the substrate in a cleaning solution of about 1 mol/L sodium hydroxide, about 1 mol/L sodium carbonate and about 0.1 mol/L sodium dodecyl sulfonate. In an embodiment, the temperature of the cleaning solution may range from about 40° C. to about 60° C. The substrate may then be scrubbed, washed, or cleaned, with clean hot water and then rinsed, or optionally scrubbed, washed, or cleaned, with clean cold water. The grease removal process may take between about 10 and 20 minutes.

Without wishing to be bound by the theory, Applicant believes that rough treatments may make the substrate hydrophilic, and form cavities in the surface of the substrate, which may increase activation. Different substrates generally have different preferred rough treatments. For example, a preferred PI rough treatment includes application of a strong alkali adjusting agent such as one having hydrazine hydrate and potassium hydroxide. In other embodiments, PI adjusting agents are commercially available, such as SF-01 provided by ZHUHAI SMART ELECTRONIC MATERIAL Co., LTD, located in Guangdong, P.R. China. In a further embodiment, a non-limiting, preferred rough treatment for an ABS substrate may include applying a solution/mixture of concentrated sulfuric acid and chromic anhydride. In a still further embodiment, a non-limiting, preferred rough treatment for a PET substrate may include an applying a solution/mixture of potassium permanganate and sodium hydroxide.

Application of Activator to Substrate

In a non-limiting, illustrative, embodiment, the substrate and the activator may be contacted or combined at any temperature for any length of time. For example, the substrate may be quickly dipped into the activator. Preferably, the substrate and activator are contacted or combined about room temperature ranging from about 15° C. to about 40° C., alternatively from about 20° C. to about 30° C., for a time ranging from about 1 to about 5 minutes, alternatively from about 3 to 5 minutes. Without wishing to be bound by the theory, Applicant believes that the amount of time the substrate and activator are combined should be sufficiently great such that a uniform distribution of activator is applied to the substrate and sufficiently limited such that the layer of activator does not build too thick, which may cause poor adhesion.

The following examples provide additional details of some embodiments of the present disclosure:

### Example 1

In the first example, 3.422 moles of sodium hydroxide were added to 750 milliliters of deionized water to prepare a first mixture. The first mixture was stirred until dissolution. Then 0.24 moles of concentrated (12 mol/L or 38 wt %) hydrochloride, 0.013 moles of glyoxylic acid, 0.020 moles of isopropanol, and 0.832 moles of urea were added to the first mixture and stirred until dissolution to form a first solution.

0.00028 moles of palladium chloride was added to 70 milliliters of deionized water having 0.36 moles of concentrated hydrochloride to form a second mixture. The second mixture was stirred until dissolution. Then 0.00056 moles of stannous chloride was added to the second mixture, and stirred for about 12 minutes, to form a colloidal palladium mixture. The colloidal palladium mixture was then added to the first solution to form a second solution. Deionized water was then added to the second solution until the volume of the second solution was 1 liter. The second solution was then heated for about 3 hours, under a temperature of about 55° C., to form a first colloidal palladium activator (hereafter “A1”).

### Example 2

In the second example, 3.422 moles of sodium hydroxide were added to 750 milliliters of deionized water to prepare a first mixture. The first mixture was stirred until dissolution. Then 0.24 moles of concentrated (12 mol/L or 38 wt %) hydrochloride, 0.013 moles of glyoxylic acid, 0.2 moles of isopropanol, and 0.832 moles of urea were added to the first mixture and stirred until dissolution to form a first solution.

0.00028 moles of palladium chloride were added to 70 milliliters of deionized water having 0.36 moles of concentrated hydrochloride to prepare a second mixture. The second mixture was stirred until dissolution. Then 0.00056 moles of stannous chloride were added to the second mixture, and stirred for about 12 minutes, to form a colloidal palladium mixture. The colloidal palladium mixture was added to the first solution to form a second solution. Deionized water was then added to the second solution until the volume of the solution was 1 liter. The second solution was then heated for about 3 hours, under a temperature of about 55° C., to prepare a second colloidal palladium activator (hereafter “A2”).

### Example 3

In the third example, 3.422 moles of sodium hydroxide were added to 750 milliliters of deionized water to prepare a first mixture. The first mixture was stirred until dissolution. Then 0.24 moles of concentrated (12 mol/L or 38 wt %) hydrochloride, 0.005 moles of glyoxylic acid, 0.020 moles of isopropanol, and 0.832 moles of urea were added to the first mixture and stirred until dissolution to form a first solution.

0.00028 moles of palladium chloride were added to 70 milliliters of deionized water having 0.36 moles of concentrated hydrochloride to form a second mixture. The second mixture was stirred until dissolution. Then 0.00056 moles of stannous chloride were added to the second mixture, and stirred for about 12 minutes, to form a colloidal palladium mixture. The colloidal palladium mixture was then added to the first solution to form a second solution. Deionized water was then added to the second solution until the volume of the second solution was 1 liter. The second solution was then heated for about 3 hours, under a temperature of about 55° C., to form a third colloidal palladium activator (hereafter “A3”).

### Example 4

In the fourth example, 3.422 moles of sodium hydroxide were added to 750 milliliters of deionized water to prepare a first mixture. The first mixture was stirred until dissolution. Then 0.24 moles of concentrated (12 mol/L or 38 wt %) hydrochloride, 0.013 moles of glyoxylic acid, 0.020 moles of isopropanol, and 0.832 moles of urea were added to the first mixture, and stirred until dissolution to form a first solution.

0.00028 moles of palladium chloride were added to 70 milliliters of deionized water having 0.36 moles of concentrated hydrochloride to form a second mixture. The second mixture was stirred until dissolution. Then 0.00045 moles of stannous chloride were added to the second mixture, and stirred for about 12 minutes, to form a colloidal palladium mixture. The colloidal palladium mixture was then added to the first solution to form a second solution. Deionized water was added to the second solution until the volume of the second solution was 1 liter. The solution was then heated for about 3 hours, under a temperature of about 55° C., to prepare a fourth colloidal palladium activator (hereafter “A4”).

### Example 5

In the fifth example, 3.422 moles of sodium hydroxide were added to 750 milliliters of deionized water to prepare a first mixture. The first mixture was stirred until dissolution. Then 0.24 moles of concentrated (12 mol/L or 38 wt %) hydrochloride, 0.013 moles of glyoxylic acid, and 0.832 moles of urea were added to the first mixture, and stirred until dissolution to form a first solution.

0.00028 moles of palladium chloride were added to 70 milliliters of deionized water having 0.36 moles of concentrated hydrochloride to prepare a second mixture. The second mixture was stirred until dissolution. Then 0.00056 moles of stannous chloride were added to the second mixture, and stirred for about 12 minutes, to form a colloidal palladium mixture. The colloidal palladium mixture was added to the first solution to form a second solution. Deionized water was then added to the second solution until the volume of the second solution was 1 liter. The second solution was then heated for about 3 hours, under a temperature of about 55° C., to form a fifth colloidal palladium activator (hereafter “A5”).

### Comparative Example 1

The colloidal palladium activator of Comparative Example 1 was prepared in the same manner as the colloidal palladium activator of Example 1, with the following exception: 1.5 grams of vanillin was substituted for the 0.013 moles of glyoxylic acid used within Example 1, to form a first comparative colloidal palladium activator (hereafter “D1”).

### Comparative Example 2

In the second comparative example, 3.422 moles of sodium hydroxide were added to 750 milliliters of deionized water to prepare a first mixture. The first mixture was stirred until dissolution. Then 0.24 moles of concentrated (12 mol/L or 38 wt %) hydrochloride, 0.020 moles of isopropanol, and 0.5 moles of urea were added to the first mixture, and stirred until dissolution to form a first solution.

0.00028 moles of palladium chloride were added to 70 milliliters of deionized water having 0.36 moles of concentrated hydrochloride to form a second mixture. The second mixture was stirred until dissolution. Then 0.00056 moles of stannous chloride were added to the second mixture, and stirred for about 12 minutes, to form a colloidal palladium mixture. The colloidal palladium mixture was then added to the first solution to form a second solution. Deionized water was added to the second solution until the volume of the second solution was 1 liter. The second solution was then heated for about 3 hours, under a temperature of about 55° C., to prepare a second comparative colloidal palladium activator (hereafter “D2”).

### Example 6

In Example 6, a PI membrane—having a size of 5 cm×5 cm×0.05 cm—was immersed in a first solution for about 8 minutes, under a temperature of about 50° C. The first solution contained about 1 mol/L sodium hydroxide; about 1 mol/L sodium carbonate; and about 0.1 mon sodium dodecyl sulfonate. The PI membrane was then cleaned with clean water.

Then, the membrane was immersed in SF-01 adjusting agent for about 7 minutes, under a temperature of about 35° C. The PI membrane was then cleaned again with clean water. The PI membrane was then dried by a fan dram.

Then, the dried PI membrane was then immersed in A1 for about 3 minutes. Following immersion in A1, the PI membrane was cleaned with deionized water, and dispergated in a 10 vt % hydrochloride solution for about 5 minutes.

The PI membrane was cleaned again with deionized water, and plated in 200 milliliter plating solution for about 20 minutes. The plating solution included 0.040 mol/L copper sulfate; 0.107 mol/L EDTA; 0.0000237 mol/L potassium ferrocyanide; 0.00230 mol/L sodium dodecyl sulfonate; 0.000192 mol/L 2,2′-bipyridine; and 0.0304 mol/L glyoxylic acid.

The PI membrane was cleaned again with deionized water to form a first plating element (hereafter “A6”).

### Examples 7 Through 10

The plating elements of Examples 7 through 10 were prepared in the same manner as the first plating element with the following exception: A2-A5 were respectively used in place of A1 of Example 6 to form a second plating element (hereafter “A7”), a third plating element (hereafter “A8”), a fourth plaiting element (hereafter “A9”), and a fifth plating element (hereafter “A10”).

### Comparative Examples 3 and 4

The plating elements of Comparative Examples 3 and 4 were prepared in the same manner as the first plating element with the following exception: D1 and D2 were respectively used in place of A1 of Example 6 to form a first comparative plating element (hereafter “D3”) and a second comparative plating element (hereafter “D4).

Testing

Activation Life

50 milliliters of A1-A5, and D1-D2, were separately placed in seven 50 milliliter colorimetric tubes, under room temperature (25° C.). The colorimetric tubes were not covered, and the time that colloidal palladium changed color was recorded. The results are reproduced below in Table 1.

Activity

During the plating process of Examples 6-10 and Comparative Examples 3-4, the following parameters were recorded: 1) initiating cycle, which was the time from the immersion of the PI membrane to foaming occurring on the surface of substrate; 2) sufficiently covering time, which is the time from the immersion of the PI membrane to the whole plating of the surface of the substrate. The results are reproduced below in Table 1. A6-A10 and D3-D4 were tested as below, and the results were shown in Table 2.

Thicknesses of the Plating Layers

Thicknesses of the plating layers were tested by a Membrane Testing Instrument (CMI900 available from Oxford instrument).

Adhesive Strength

100 lattices each having a size of 1 millimeter by 1 millimeter were cut on the plating layers. Transparent adhesive tape (type 600 available from Minnesota Mining & Manufacturing Company) was bonded on the lattices and taken off as soon as possible, in a direction of an angle of about 60° with the surface of the layer. If no layers dropped, the adhesive strength was represented by 5B; if 0 to 5 percent of the layers dropped, the adhesive strength was 4B; if 5 to 15 percent of the layers dropped, the adhesive strength was 3B; if 15 to 35 percent of the layers dropped, the adhesive strength was 2B; if 35 to 65 percent of the layers dropped, the adhesive strength was 1B; if more than 65 percent of the layers dropped, the adhesive strength was 0B.

Surface Conditions of the Layers

The surface conditions of the layers were observed by an SEM scan microscope (commercially available from SOHO-WORK Co, Ltd).

TABLE 1

| | Life in | Initiation cycle | Sufficient covering |
|---|---|---|---|
| Samples | days | in seconds | time in seconds |
| A1 | +180 | 10 | 127 |
| A2 | +180 | 9 | 113 |
| A3 | 157 | 15 | 138 |
| A4 | 140 | 15 | 135 |
| A5 | +180 | 16 | 135 |
| D1 | 130 | 20 | 146 |
| D2 | 51 | 31 | 197 |

TABLE 2

| | Thickness of | Adhesive | |
|---|---|---|---|
| Samples | the layers μm | strength | State of the surfaces |
| A6 | 1.1 | 4B | bright no pinholes no cracks |
| A7 | 1.2 | 5B | bright no pinholes no cracks |
| A8 | 1.0 | 4B | bright no pinholes no cracks |
| A9 | 0.7 | 4B | bright no pinholes no cracks |
| A10 | 0.9 | 4B | bright no pinholes no cracks |
| D3 | 0.6 | 3B | bright no pinholes no cracks |
| D4 | 0.4 | 2B | dark pinholes uneven |
| | | | thicknesses |

What is claimed is:

1. A colloidal palladium activator comprising: colloidal palladium particles; sodium chloride; glyoxylic acid; hydrochloride solution; stannous chloride; and a stabilizer.

2. The colloidal palladium activator of claim 1, wherein the colloidal palladium activator has a concentration ranging from about 0.0002 mol/L to about 0.006 mol/L.

3. The colloidal palladium activator of claim 1, wherein the sodium chloride has a concentration ranging from about 2.567 mol/L to about 3.765 mol/L.

4. The colloidal palladium activator of claim 1, wherein the glyoxylic acid has a concentration ranging from about 0.002 mol/L to about 0.35 mol/L.

5. The colloidal palladium activator of claim 1, wherein the hydrochloride solution has a concentration ranging from about 0.12 mol/L to about 0.96 mol/L.

6. The colloidal palladium activator of claim 1, wherein the stannous chloride has a concentration ranging from about 0.022 mol/L to about 0.088 mol/L.

7. The colloidal palladium activator of claim 1, wherein the stabilizer has a concentration ranging from about 0.001 mol/L to about 1 mol/L.

8. The colloidal palladium activator of claim 1, wherein the stabilizer is a compound selected from the group consisting of: sodium stannate; carbamide; ascorbic acid; and combinations thereof.

9. The colloidal palladium activator of claim 1, wherein the colloidal palladium particles have an average particle diameter of about 80 nanometers to about 300 nanometers.

10. The colloidal palladium activator of claim 1, wherein the colloidal palladium particles have an average particle diameter of about 80 nanometers to about 200 nanometers.

11. The colloidal palladium activator of claim 1, wherein the colloidal palladium activator further comprises a surface wetting agent.

12. The colloidal palladium activator of claim 11, wherein the surface wetting agent is an alcohol selected from the group consisting of: isopropanol; methanol; ethanol; and combinations thereof.

13. The colloidal palladium activator according to claim 11, wherein the surface wetting agent has a concentration ranging from about 0.003 mol/L to about 0.3 mol/L.

14. The colloidal palladium activator according to claim 11, wherein the surface wetting agent has a concentration ranging from about 0.01 mol/L to about 0.2 mol/L.

15. The colloidal palladium activator according to claim 1, wherein the colloidal palladium activator has a PH value ranging from about 0.2 to about 0.9.

16. The colloidal palladium activator according to claim 15, wherein the colloidal palladium activator has a PH value ranging from about 0.5 to about 0.7.

17. A method of preparing a colloidal palladium activator comprising:
combining a first hydrochloride solution, a stannous chloride, a glyoxylic acid, and a stabilizer with a sodium chloride solution to form a first solution;
combining palladium sodium with a second hydrochloride solution to form a second solution;
combining stannous chloride to the second solution to form a third solution; and
combining the first and third solution to form the colloidal palladium activator.

18. A method for activating substrates comprising: contacting the substrate with the activator of claim 1 to form an active substrate having a plurality of active centers.

19. The method of claim 18, wherein substrate is contacted with the activator of claim for an amount of time ranging from about 1 minute to about 5 minutes, and at a temperature ranging from about 15° C. to about 40° C.

20. The method of claim 18, wherein the substrate is pretreated prior to being contacted with the activator of claim 1, wherein the pretreatment is selected from the group consisting of: grease removal, rough treatment, and combinations thereof.
